(19) United States
(12) Patent Application Publication
(10) Pub. No.: US 2020/0020117 A1
(43) Pub. Date: Jan. 16, 2020

(54) POSE ESTIMATION

(71) Applicant: Ford Global Technologies, LLC, Dearborn, MI (US)

(72) Inventors: LEDA DAEHLER, Dearborn, MI (US); GINTARAS VINCENT PUSKORIUS, Novi, MI (US); GAUTHAM SHOLINGAR, Sunnyvale, CA (US)

(73) Assignee: Ford Global Technologies, LLC, Dearborn, MI (US)

(21) Appl. No.: 16/036,274

(22) Filed: Jul. 16, 2018

(51) Int. Cl. G06T 7/33; G06T 7/10; G06N 3/08; G06T 11/20; G06N 5/04; G06N 99/00

(52) U.S. Cl. CPC G06T 7/33; G06T 7/10; G06N 3/084; G06T 11/20; G06T 2210/12; G06N 99/005; G06T 2207/30244; G06T 2207/30236; G06N 5/046

(57) ABSTRACT

A computing system can crop an image based on a width, height and location of a first vehicle in the image. The computing system can estimate a pose of the first vehicle based on inputting the cropped image and the width, height and location of the first vehicle into a deep neural network. The computing system can then operate a second vehicle based on the estimated pose.

### BACKGROUND

Vehicles can be equipped to operate in both autonomous and occupant piloted mode. Vehicles can be equipped with computing devices, networks, sensors and controllers to acquire information regarding the vehicle's environment and to operate the vehicle based on the information. Safe and comfortable operation of the vehicle can depend upon acquiring accurate and timely information regarding the vehicle's environment. Vehicle sensors can provide data concerning routes to be traveled and objects to be avoided in the vehicle's environment. Safe and efficient operation of the vehicle can depend upon acquiring accurate and timely information regarding routes and objects in a vehicle's environment while the vehicle is being operated on a roadway. There are existing mechanisms to identify objects that pose risk of collision and/or should be taken into account in planning a vehicle's path along a route. However, there is room to improve object identification and evaluation technologies.

### BRIEF DESCRIPTION OF THE DRAWINGS

FIG. 1 is a block diagram of an example vehicle.

FIG. 2 is a diagram of an example image of a traffic scene.

FIG. 3 is a diagram of an example image of a traffic scene.

FIG. 4 is a diagram of an example deep neural network.

FIG. 5 is a flowchart diagram of an example process to estimate vehicle pose based on a cropped image.

### DETAILED DESCRIPTION

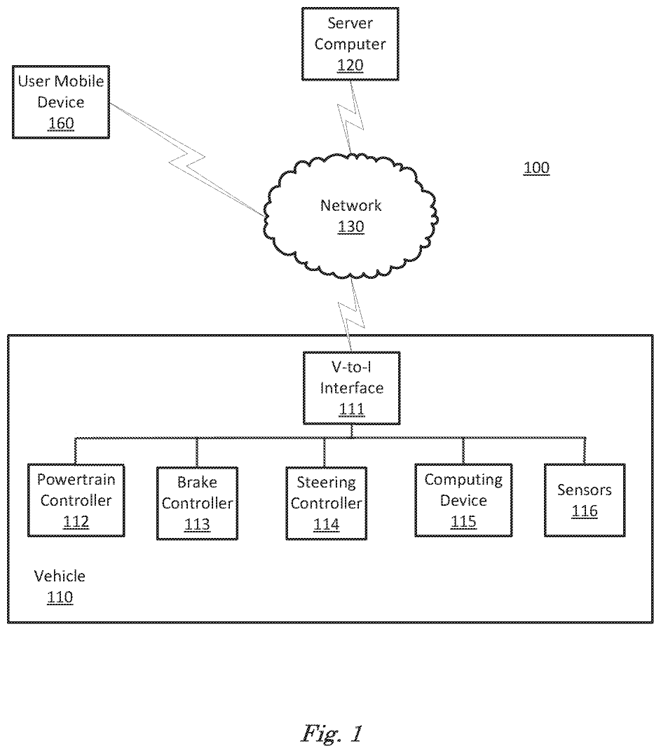

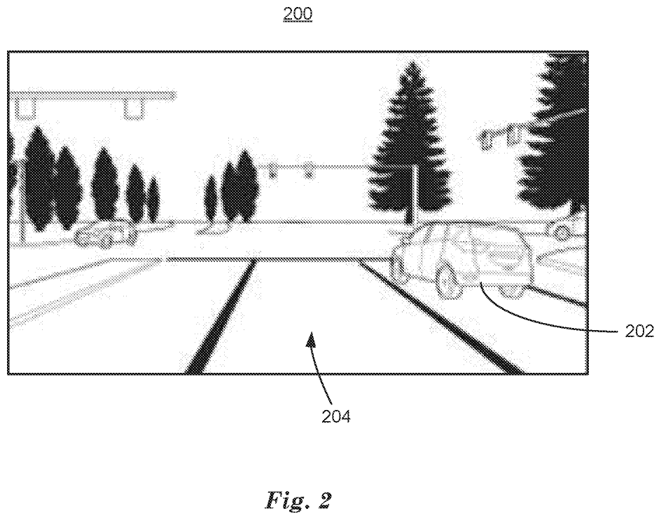

A computing device in a vehicle can be programmed to acquire data regarding the external environment around a vehicle and to use the data to determine trajectories to be used to operate the vehicle in autonomous and semi-autonomous modes. The computing device can detect and track traffic objects in an environment around a vehicle, where a traffic object is defined as a rigid or semi-rigid three-dimensional (3D) solid object occupying physical space in the real world surrounding a vehicle. Examples of traffic objects include vehicles and pedestrians, etc., as discussed below in relation to FIG. 2. Detecting and tracking traffic objects can include determining a plurality of estimates of the location of a traffic object with respect to the vehicle to determine motion and thereby predict future locations of traffic objects and thereby permit computing device to determine a path for the vehicle to travel that avoids a collision or other undesirable event involving the traffic object. The computing device can use a lidar sensor as discussed below in relation to FIG. 1 to determine distances to traffic objects in a vehicle's environment, however, a plurality of lidar data samples over time can be required to estimate a trajectory for the traffic object and predict a future location. Techniques discussed herein can estimate a 3D location and orientation as defined in relation to FIG. 2, below, in real world coordinates for traffic objects in a vehicle's environment and thereby permit a computing device to predict a future location for a traffic object based on a color video image of the vehicle's environment.

Disclosed herein is a method, including cropping an image based on a width, height and center of a first vehicle in the image to determine an image patch, estimating a 3D pose of the first vehicle based on inputting the image patch and the width, height and center of the first vehicle into a deep neural network, and, operating a second vehicle based on the estimated 3D pose. The estimated 3D pose can include an estimated 3D position, an estimated roll, an estimated pitch and an estimated yaw of the first vehicle with respect to a 3D coordinate system. The width, height and center of the first vehicle image patch can be determined based on determining objects in the image based on segmenting the image. Determining the width, height and center of the first vehicle can be based on determining a rectangular bounding box in the segmented image. Determining the image patch can be based on cropping and resizing image data from the rectangular bounding box to fit an empirically determined height and width. The deep neural network can include a plurality of convolutional neural network layers to process the cropped image, a first plurality of fully-connected neural network layers to process the height, width and location of the first vehicle and a second plurality of fully-connected neural network layers to combine output from the convolutional neural network layers and the first fully-connected neural network layers to determine the estimated pose.

Determining an estimated 3D pose of the first vehicle can be based on inputting the width, height and center of the first vehicle image patch into the deep neural network to determine estimated roll, an estimated pitch and an estimated yaw. An estimated 3D pose of the first vehicle can be determined wherein the deep neural network includes a third plurality of fully-connected neural network layers to process the height, width and center of the first vehicle image patch to determine a 3D position. The deep neural network can be trained to estimate 3D pose based on an image patch, width, height, and center of a first vehicle and ground truth regarding the 3D pose of a first vehicle based on simulated image data. Ground truth regarding the 3D pose of the first vehicle can include a 3D position, a roll, a pitch and a yaw with respect to a 3D coordinate system. The deep neural network can be trained to estimate 3D pose based on an image patch, width, height, and center of a first vehicle and ground truth regarding the 3D pose of a first vehicle based on recorded image data and acquired ground truth. The recorded image data is can be recorded from video sensors included in the second vehicle. The ground truth corresponding to the recorded image data can be determined based on photogrammetry. Photogrammetry can be based on determining a dimension of a vehicle based on the vehicle make and model.

Further disclosed is a computer readable medium, storing program instructions for executing some or all of the above method steps. Further disclosed is a computer programmed for executing some or all of the above method steps, including a computer apparatus, programmed to crop an image based on a width, height and center of a first vehicle in the image to determine an image patch, estimate a 3D pose of the first vehicle based on inputting the image patch and the width, height and center of the first vehicle into a deep neural network, and, operate a second vehicle based on the estimated 3D pose. The estimated 3D pose can include an estimated 3D position, an estimated roll, an estimated pitch and an estimated yaw of the first vehicle with respect to a 3D coordinate system. The width, height and center of the first vehicle image patch can be determined based on determining objects in the image based on segmenting the image. Determining the width, height and center of the first vehicle can be based on determining a rectangular bounding box in the segmented image. Determining the image patch can be based on cropping and resizing image data from the rectangular bounding box to fit an empirically determined height and width. The deep neural network can include a plurality of convolutional neural network layers to process the cropped image, a first plurality of fully-connected neural network layers to process the height, width and location of the first vehicle and a second plurality of fully-connected neural network layers to combine output from the convolutional neural network layers and the first fully-connected neural network layers to determine the estimated pose.

The computer apparatus can be further programmed to determine an estimated 3D pose of the first vehicle can be based on inputting the width, height and center of the first vehicle image patch into the deep neural network to determine estimated roll, an estimated pitch and an estimated yaw. An estimated 3D pose of the first vehicle can be determined wherein the deep neural network includes a third plurality of fully-connected neural network layers to process the height, width and center of the first vehicle image patch to determine a 3D position. The deep neural network can be trained to estimate 3D pose based on an image patch, width, height, and center of a first vehicle and ground truth regarding the 3D pose of a first vehicle based on simulated image data. Ground truth regarding the 3D pose of the first vehicle can include a 3D position, a roll, a pitch and a yaw with respect to a 3D coordinate system. The deep neural network can be trained to estimate 3D pose based on an image patch, width, height, and center of a first vehicle and ground truth regarding the 3D pose of a first vehicle based on recorded image data and acquired ground truth. The recorded image data is can be recorded from video sensors included in the second vehicle. The ground truth corresponding to the recorded image data can be determined based on photogrammetry. Photogrammetry can be based on determining a dimension of a vehicle based on the vehicle make and model.

FIG. 1 is a diagram of a vehicle information system 100 that includes a vehicle 110 operable in autonomous (“autonomous” by itself in this disclosure means “fully autonomous”) and occupant piloted (also referred to as non-autonomous) mode. Vehicle 110 also includes one or more computing devices 115 for performing computations for piloting the vehicle 110 during autonomous operation. Computing devices 115 can receive information regarding the operation of the vehicle from sensors 116. The computing device 115 may operate the vehicle 110 in an autonomous mode, a semi-autonomous mode, or a non-autonomous mode. For purposes of this disclosure, an autonomous mode is defined as one in which each of vehicle 110 propulsion, braking, and steering are controlled by the computing device; in a semi-autonomous mode the computing device 115 controls one or two of vehicle's 110 propulsion, braking, and steering; in a non-autonomous mode, a human operator controls the vehicle propulsion, braking, and steering.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network, e.g., including a bus in the vehicle 110 such as a controller area network (CAN) or the like; the vehicle 110 network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, includes hardware, firmware, and software that permits computing device 115 to communicate with a remote server computer 120 via a network 130 such as wireless Internet (Wi-Fi) or cellular networks. V-to-I interface 111 may accordingly include processors, memory, transceivers, etc., configured to utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks, e.g., according to Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log information by storing the information in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executable by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve safe and efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to control a specific vehicle subsystem. Examples include a powertrain controller 112, a brake controller 113, and a steering controller 114. A controller is typically an electronic control unit (ECU) or the like such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113 and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computer 115 and control actuators based on the instructions.

Sensors 116 may include a variety of devices known to provide data via the vehicle communications bus. For example, a radar fixed to a front, e.g., a front bumper (not shown), of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously.

The vehicle 110 is generally a land-based semi-autonomous and/or autonomous-capable vehicle 110 having three or more wheels, e.g., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

FIG. 2 is a diagram of an example color image 200 of a traffic scene rendered in black and white to comply with 37 C.F.R. § 1.84(a)(1). Color image 200 can be acquired by a video sensor 116 included in a vehicle 110. Video sensor 116 can acquire color video data and transmit the color video data to computing device 115, which can store the color video data in non-volatile memory where it can be recalled by computing device 115 and processed. As discussed above in regard to FIG. 1, computing device 115 can be programmed to operate vehicle 110 based, in part, on color video data from a video sensor 116. Computing device 115 can be programmed to recognize traffic objects in color image 200 including other vehicle 202 and roadway 204. For example, a deep neural network (DNN) can be programmed to segment and categorize traffic objects including vehicles, pedestrians, barriers, traffic signals, traffic markings, roadways, foliage, terrain and buildings. Applying DNNs to segment traffic objects in color video data is the subject of current academic and industrial research. Academic research groups and some commercial entities have developed libraries and toolkits that can be used to develop DNNs for image segmentation tasks, including traffic object segmentation. For example, Caffe is a convolutional neural network library created by Berkeley Vision and Learning Center, University of California, Berkeley, Berkeley, Calif. 94720, that can be used to develop a traffic object segmentation DNN.

Image segmentation is a machine vision process wherein an input color image is segmented into connected regions. A DNN can be trained to segment an input color image into connected regions by inputting a plurality of color images along with “ground truth” data. Ground truth is defined as information or data specifying a real world condition or state associated with image data. For example, in an image of a traffic scene, ground truth data can include information on traffic objects included in the color image, such as area and distance and direction from the color video sensor 116 to a vehicle in the field of view. Ground truth data can be acquired independently from the color image, for example by direct observation or measurement, or by processing that is independent from the DNN processing. Ground truth data can be used to provide feedback to the DNN during training, to reward correct results and punish bad results. By performing a plurality of trials with a plurality of different DNN parameters and assessing the results with ground truth data, a DNN can be trained to output correct results upon inputting color image data. The connected regions can be subject to minimum and maximum areas, for example. The connected regions can be categorized by labeling each connected region with one of a number of different categories corresponding to traffic objects. The categories can be selected by the DNN based on the size, shape, and location of the traffic objects in color image 200. For example, a DNN can include different categories for different makes and models of vehicles.

Training a DNN to determine a 3D pose of a vehicle in an input color image 200 can require recorded color images 200 with corresponding ground truth regarding the real world 3D pose of a plurality of vehicles. Ground truth can be expressed as distance or range and direction from a color video sensor 116. In some examples, computing device 115 can determine a distance or range from the color video sensor 116 to a traffic object in color image 200 by photogrammetry (i.e., techniques such as are known for making measurements from photographs or images). Photogrammetry can combine information regarding a field of view including magnification, locations and three-dimensional (3D) optical axis direction of a lens of a color video sensor 116 with information regarding real world size of a traffic object to estimate the distance and direction from a lens of a color video sensor 116 to a traffic object. For example, information regarding the real world height of other vehicle 202 can be combined with color image 200 height information in pixels of a traffic object associated with other vehicle 202, and based on the magnification and 3D direction of the lens, determine a distance and direction to the other vehicle 202 with respect to vehicle 110.

Determining distances and directions based on photogrammetry depends upon determining location and pose of traffic objects. Traffic objects are assumed to be rigid 3D objects (vehicles, etc.) or semi-rigid 3D objects (pedestrians, etc.); therefore traffic object position and orientation in real world 3D space can be described by six degrees of freedom about a three-axis coordinate system. Assuming an x, y, z three-axis coordinate system with a defined origin, 3D location can be defined as translation from the origin in x, y, z coordinates and pose can be defined as angular rotations (roll, pitch and yaw) about the x, y, and z axes respectively. Location and pose can describe, respectively, the position and orientation (e.g., angles with respect to each of x, y, and z axes, possibly expressed, e.g., with respect to a vehicle, as a roll, pitch, and yaw) of traffic objects in real world 3D space. Estimates of roll, pitch, and yaw for a traffic object are referred to as a predicted orientation. An orientation combined with a 3D location will be referred to as 3D pose herein, and a predicted orientation combined with a predicted 3D location will be referred to as predicted 3D pose herein.

Photogrammetry can determine the location of a data point in a color image 200, for example, and based on information regarding the field of view of the color video sensor 116 that acquired the color image 200 and an estimate of the distance from a 3D point in the color video sensor to the data point in real world 3D space. For example, the distance from the 3D point in the color video sensor to the data point in real world 3D space can be estimated using a priori information regarding the data point. For example, the data point can be assumed to be included in a categorized traffic object identified, e.g., according to conventional object recognition and/or classification techniques, by computing device 115 from data of one or more sensors 116. The traffic object category can be used by computing device 115 to recall a priori information regarding the real world (i.e., actual) size of the traffic object. A real world size of a traffic object can be defined as the size of a measurable dimension, for example overall height, length or width. For example, passenger vehicles are manufactured at standard dimensions. An image of a make and model of passenger vehicle can be recognized by computing device 115 using machine vision techniques and based on measurable dimensions of that vehicle in real world units, for example millimeters, that can be recalled from a list of vehicle measurable dimensions stored at computing device 115. The size of the measurable dimension as measured in pixels in the color image can be compared to a size of the measurable dimension in real world units to determine a distance of the traffic object from the color video sensor 116 based on the magnification of a lens included in the color video sensor 116 and a location of the measurable dimension with respect to an intersection of an optical axis included in the lens and an image sensor plane included in a color video sensor 116 for example. A priori information regarding a measurable dimension can be combined with measured locations and sizes of traffic objects in color image 200 and information regarding the magnification of the color video sensor 116 lens in this fashion to estimate a real world 3D distance from the color video sensor to the categorized traffic object.

In some examples, computing device can determine a distance or range from a color video sensor 116 to a traffic object in color image 200 by acquiring and processing information from a lidar sensor 116. As discussed above in relation to FIG. 1, a lidar sensor 116 can acquire a point cloud of data points that represent locations of surfaces in 3D space. A location of the other vehicle 302 with respect to vehicle 110 can be determined by projecting an estimated 3D location of a 3D lidar data point determined to be associated with other vehicle 302 into color image 300 based on the field of view of color image sensor 116. A 3D lidar data point can be determined to be associated with the other vehicle by based on comparing the fields of view of color image sensor 116 and lidar sensor 116.

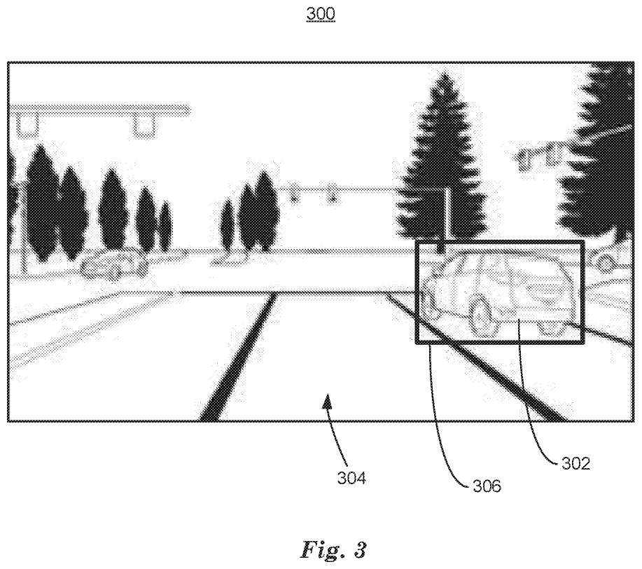

FIG. 3 is an example color image 300 of a traffic scene rendered in black and white. Computing device 115 can be programmed to recognize traffic objects in color image 300 including other vehicle 302 and roadway 304 as discussed above in relation to FIG. 2. Based on traffic object data associated with other vehicle 302, a rectangular bounding box 306 can be constructed around other vehicle 302.

Bounding box 306 can be constructed based on segmented traffic object data from color image data 300. Based on determining a traffic object with category “vehicle” at a location in color image 300 consistent with other vehicle 302, computing device 115 can construct a bounding box by determining the smallest rectangular shape that includes image pixels in a connected region of color image 300 determined to belong the category “vehicle,” wherein the sides of the bounding box are constrained to be parallel to the sides (top, bottom, left, right) of color image 300. Bounding box 306 is described by contextual information including a center, which is expressed as x, y coordinates in pixels relative to an origin, a width in pixels and a height in pixels. The x, y coordinates of a center can be the center of the bounding box. The height and width of the bounding box can be determined by the maximum and minimum x and maximum and minimum y coordinates of pixels included in the connected region.

Color image 300 can be cropped based on bounding box 306. In cropping, all pixels of color image 300 that are not within bounding box 306 are discarded. Color image 300 then includes only the pixels within bounding box 306. Since bounding box 306 includes many fewer pixels than original, uncropped color image 300, processing of cropped color image 300 can be many times faster, thereby improving processing related to predicting a 3D pose.

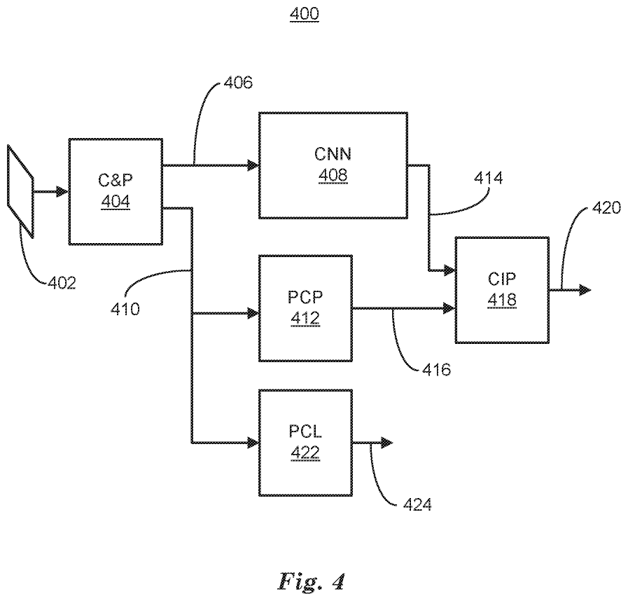

Cropped color image 300 and contextual information regarding the location and size of the cropped color image 300 with respect to original, uncropped color image 300 can be input to a DNN, described in relation to FIG. 4, below, to determine a pose prediction, i.e., estimated roll, pitch and yaw, for other vehicle 302. A pose prediction can be used by computing device 115 to predict movement for other vehicle 302 and thereby assist computing device 115 in safely and efficiently operating vehicle 110 by avoiding collisions and near-collisions and traveling a shortest path consistent with safe operation.

FIG. 4 is a diagram of an example pose prediction DNN 400, i.e., a machine learning program that can be trained to output predicted orientation 420 and predicted position 424 in response to an input color image 402. A predicted orientation 420 and a predicted position 424 is a prediction or estimation of a real world 3D pose (location, roll, pitch, and yaw) as defined above in relation to FIG. 2, predicted from analysis of an image of another vehicle included in input color video image 402. DNN 400 can output a location prediction 424 in response to an input color image 402. A location prediction is a real world 3D location (x, y, z) as defined above in relation to FIG. 2, predicted from an image of the other vehicle included in input color video image 402. DNN 400 can be trained based on a plurality of input color images that include ground truth specifying the real world 3D location and pose of vehicles included in the input color images. Training DNN 400 includes inputting a color image 402, and back-propagating a resulting output pose prediction 420 to be compared to ground truth associated with an input color image 402.

As defined above, ground truth can be the correct real world 3D pose for the vehicle pictured in color image 402 determined with respect to a color video sensor 116 included in vehicle 110. Ground truth information can be obtained from a source independent of color image 402. For example, the 3D pose of another vehicle with respect to a color video sensor 116 can be physically measured and then a color image 402 of the other vehicle can be acquired and the ground truth and the acquired image used for training DNN 400. In other examples, simulated data can be used to create color image 402. In this example the 3D pose is input to a simulation program. Simulated data can be created by software programs similar to video game software programs that can render output video images photo-realistically, e.g. the output video images look like photographs of real world scenes.

By comparing results of DNN 400 processing with ground truth and positively or negatively rewarding the process, the behavior of DNN 400 can be influenced or trained after repeated trials to provide correct answers with respect to ground truth when corresponding color images 402 are input for a variety of different color images 402. Training DNN 400 in this fashion trains component neural networks convolutional neural network (CNN) block 408 and process crop pose (PCP) block 412, to output correct image features 414 and correct pose features 416, respectively, as input to combine image pose CIP block 418 in response to input color image 402, without explicitly having to provide ground truth for these intermediate features. Ground truth regarding orientation prediction 420 and location prediction 424 is compared to output from combine image pose (CIP) block and process crop location (PCL) block 422 to train DNN 400.

As the first step in processing a color image 402 with DNN 400, computing device 115 can input a color image 402 to crop and pad (C&P) block 404 wherein a color video image 402 is cropped, resized and padded. A color image 402 can be cropped by determining a bounding box associated with an image of a vehicle and discarding all pixels outside of the bounding box, as discussed above in relation to FIG. 3. The resulting cropped color image can have a height and width in pixels that is different than an input height and width required by CNN block 408. To remedy this, the cropped color image can be resized by expanding or contracting the cropped color image until the height and width or cropped color image is equal to an input height and width required by CNN block 408, for example 100×100 pixels. The cropped color image can be expanded by replicating pixels and can be contracted by sampling pixels. Spatial filters can be applied while expanding and contracting the cropped color image to improve accuracy. The cropped color image can also be padded by adding rows and columns of pixels along the top, bottom, left and right edges of the cropped and resized color image to improve the accuracy of convolution operations performed by CNN block 408. The cropped, resized and padded color image 406 is output to CNN block 408.

CNN block 408 processes cropped, resized, and padded color image 406 by convolving the input cropped, resized and padded color image 406 successively with a plurality of convolution layers using a plurality of convolution kernels followed by pooling, wherein intermediate results output from a convolutional layer can be spatially reduced in resolution by combining contiguous neighborhoods of pixels, for example 2×2 neighborhoods, into a single pixels according to a rule, for example determining a maximum or a median value of the neighborhood pixels. Intermediate results from a convolutional layer can also be spatially expanded by including information from previously determined higher resolution convolutional layers via skip connections, for example. CNN block 408 can be trained by determining sequences of convolution kernels to be used by convolutional layers of CNN block 408 based on comparing results from DNN 400 with ground truth regarding vehicle orientation and location. CNN block 408 outputs image features 414 to CIP block 418, where they are combined with pose features 416 output by PCP block 412 to form output orientation predictions 420.

Returning to C&P block 404, C&P block 404 outputs crop information 410 based on input color image 402 to PCP block 412 and PCL block 422. Crop information includes the original height and width of the cropped color image in pixels and the x, y coordinates of the center of the cropped color image with respect to the origin of the color image 402 coordinate system in pixels. PCP block 412 inputs the crop information 410 into a plurality of fully-connected neural network layers, which process the crop information 410 to form orientation features 416 to output to CIP 418. At training time, parameters included as coefficients in equations included in PCP 412 that combine values in fully-connected layers form output orientation features 416, can be adjusted or set to cause PCP 412 output desired values based on ground truth. In parallel with this, PCL 422 inputs the crop information and determines a real world 3D location for the vehicle represented in cropped, resized and padded color image 406 to output as location prediction 424, which includes x, y, and z coordinates representing an estimate of the real world 3D location of the vehicle represented in input color image 402. PCL 422 can be trained by adjusting or setting parameters included as coefficients in equations included in PCL 422 that combine values in fully-connected layers to output correct values in response to cropped image input based on ground truth.

CIP block 418 inputs image features 414 and orientation features 416 into a plurality of fully connected neural network layers to determine an orientation prediction 420. Orientation prediction 420 is an estimate of the orientation of a vehicle represented in input color image 402 expressed as roll, pitch, and yaw, in degrees, about the axes of a camera 3D coordinate system as described above in relation to FIG. 2. At training time, parameters included as coefficients in equations included in CIP block 418 that combine values in fully-connected layers form output orientation predictions 420, can be adjusted or set to cause CIP 418 to output desired values based on ground truth. An orientation prediction 420 and a location prediction 424 can be combined to form a predicted 3D pose for a vehicle and output the 3D pose to computing device 115 for storage and recall for use in operating vehicle 110. For example, information regarding location and pose for a vehicle in a field of view of a video sensor 116 included in vehicle 110 can be used to operate vehicle 110 so as to avoid collisions or near-collisions with a vehicle in the field of view.

DNN 400 can be trained based on recorded input color video images 402 and corresponding ground truth regarding the 3D pose of vehicles included in input color video images 402. Input color video images 402 and corresponding ground truth can be obtained by recording real world scenes and measuring 3D pose, for example Techniques discussed herein can also obtain input color video images 402 and corresponding ground truth regarding the 3D pose of vehicles included in color video images based on computer simulations. A computing device can render color video images based on digital data describing surfaces and objects in photo-realistic fashion, to mimic real world weather and lighting conditions according to season and time of day for a plurality of vehicles. locations and poses. Because the color video images 402 can be synthetic, 3D pose of included vehicles is included in the digital data, so ground truth is known precisely, with no measurement error as is possible with real world data. Errors included in real world data can be included in the simulated data by deliberately adjusting the bounding box 306 by scaling or shifting for additional training, for example.

Computing device 115 can operate vehicle 110 based on a multi-level control process hierarchy wherein a plurality of cooperating, independent control processes create and exchange information regarding vehicle 110 and its environment including real world traffic objects to safely operate vehicle 110 from its current location to a destination, wherein safe operation of vehicle 110 includes avoiding collisions and near-collisions. Example techniques discussed herein allow for improved control processes to determine information regarding vehicle 110 operation, namely predicted 3D pose including orientation (roll, pitch, and yaw) and location (x, y, and z) of a traffic object (a vehicle) in the real world environment of vehicle 110. Other control processes can determine a destination in real world coordinates based on vehicle location information and mapping data. Further control processes can determine a predicted polynomial path based on lateral and longitudinal acceleration limits and empirically determined minimum distances for avoiding traffic objects which can be used by still further control processes to operate vehicle 110 to the determined destination. Still further control processes determine control signals to be sent to controllers 112, 113, 114 to operate vehicle 110 by controlling steering, braking and powertrain based on operating vehicle 110 to travel along the predicted polynomial path.

Techniques described herein for determining a predicted 3D pose for a vehicle included in a color video image can be included in a multi-level control process hierarchy by outputting predicted 3D pose information from DNN 400 to a control process executing on computing device 115 that determines predicts vehicle movement based on 3D pose with respect to vehicle 110 and a roadway including map information. Predicting movement for vehicles in a field of view of a color video sensor 116 can permit computing device 115 to determine a path represented by a polynomial path function that can be used by computing device 115 to operate vehicle 110 along to safely accomplish autonomous and semi-autonomous operation by predicting locations of other vehicles and planning the polynomial path accordingly. For example, computing device 115 can operate vehicle 110 to perform semi-autonomous tasks including driver assist tasks like lane change maneuvers, cruise control, and parking, etc.

Performing driver assist tasks like lane change maneuvers, cruise control, and parking, etc., can include operating vehicle 110 by determining a polynomial path and operating vehicle 110 along the polynomial path by applying lateral and longitudinal acceleration via controlling steering, braking and powertrain components of vehicle 110. Performing driver assist tasks can require modifying vehicle 110 speed to maintain minimum vehicle-to-vehicle distances or to match speeds with other vehicles to merge with traffic during a lane change maneuver, for example. Predicting movement and location for other vehicles in a field of view of sensors 116 included in vehicle 110 based on determining other vehicle pose and location in real world coordinates can be included in polynomial path planning by computing device 115. Including predicted pose and location in polynomial path planning can permit computing device 115 to operate vehicle 110 to perform vehicle assist tasks safely.

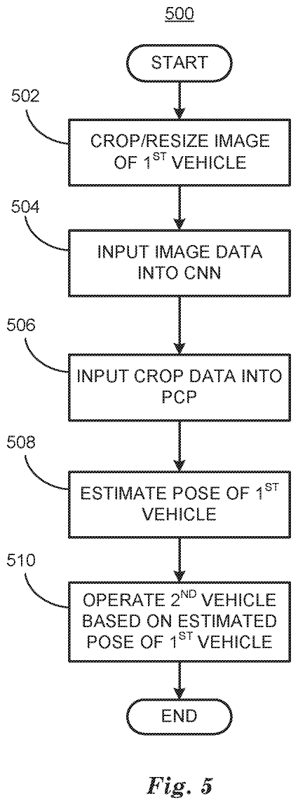

FIG. 5 is a flowchart, described in relation to FIGS. 1-4, of an example process 500 for operating a second vehicle 110 based on predicting an estimated 3D pose for a first vehicle. Process 500 can be implemented by a processor of computing device 115, taking as input information from sensors 116, and executing commands and sending control signals via controllers 112, 113, 114, for example. Process 500 is described herein as including multiple steps taken in disclosed specified order. Other implementations are possible in which process 500 includes fewer steps and/or includes the disclosed steps taken in different orders.

Process 500 begins at step 502, where a computing device 115 included in a second vehicle 110 crops, resizes and pads a color image 402 that includes a representation of a first vehicle. As discussed in relation to FIGS. 3 and 4, above, the color image 402 is cropped to include only the image of the first vehicle, resized to fit an input size required by DNN 400, and padded to assist convolution by CNN 408.

At step 504 computing device 115 inputs the cropped, resized and padded image data into CNN 408, where CNN 408 processes the input cropped, resized and padded color image data to form image features 414 to output to CIP 418 as discussed above in relation to FIG. 4.

At step 506 computing device 115 inputs crop data including height, width and center of the cropped color image to PCP block 412 where the crop data is processed by a plurality of fully connected neural network layers to determine pose features 416 that describe a 3D orientation associated with the other vehicle represented in input color video 402.

At step 508 computing device 115 inputs image features 414 and pose features 416 into CIP block 418 where a plurality of fully connected neural network layers process the input image features 414 and pose features 416 to determine and output an orientation prediction 420 that describes the orientation of a vehicle represented in input color image 402 in degrees of roll, pitch, and yaw with respect to a color video sensor 116 3D coordinate system. Computing device also inputs crop information 410 to PCL block 422 which processes to crop information 410 to form a predicted 3D location 424. The predicted 3D location 424 and predicted orientation 420 can be combined to form a predicted 3D pose.

At step 510, computing device 115 operates a vehicle 110 based on the 3D pose prediction output at step 508. For example, computing device 115 can use the 3D pose prediction to predict movement of a vehicle in the field of view of a color video sensor 116 included in vehicle 110. Computing device 115 use the location and predicted movement of the vehicle in the field of view of color video sensor 116 in programs that plan polynomial paths for driver assist tasks, for example. Determination of a polynomial path for vehicle 110 to follow to accomplish a driver assist task including lane change maneuvers, cruise control, or parking, can be based, in part, on predicted movement of vehicles in the field of view of color video sensor 116. Predicting movement of vehicles in a field of view of a color video sensor 116 can permit computing device 115 to operate vehicle 110 so as to avoid collision or near-collision with another vehicle while performing driver assist tasks as discussed above in relation to FIG. 4, for example.

Computing devices such as those discussed herein generally each include commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., commands), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

What is claimed is:

1. A method, comprising:
cropping an image based on a width, height and center of a first vehicle in the image to determine an image patch;
estimating a 3D pose of the first vehicle based on inputting the image patch and the width, height and center of the first vehicle into a deep neural network; and
operating a second vehicle based on the estimated 3D pose.

2. The method of claim 1, wherein the estimated 3D pose includes an estimated 3D position, an estimated roll, an estimated pitch and an estimated yaw of the first vehicle with respect to a 3D coordinate system.

3. The method of claim 1, further comprising determining the width, height and center of the first vehicle image patch based on determining objects in the image based on segmenting the image.

4. The method of claim 3, further comprising determining the width, height and center of the first vehicle based on determining a rectangular bounding box in the segmented image.

5. The method of claim 4, further comprising determining the image patch based on cropping and resizing image data from the rectangular bounding box to fit an empirically determined height and width.

6. The method of claim 1, wherein the deep neural network includes a plurality of convolutional neural network layers to process the cropped image, a first plurality of fully-connected neural network layers to process the height, width and location of the first vehicle and a second plurality of fully-connected neural network layers to combine output from the convolutional neural network layers and the first fully-connected neural network layers to determine the estimated pose.

7. The method of claim 6, further comprising determining an estimated 3D pose of the first vehicle based on inputting the width, height and center of the first vehicle image patch into the deep neural network to determine estimated roll, an estimated pitch and an estimated yaw.

8. The method of claim 7, further comprising determining an estimated 3D pose of the first vehicle wherein the deep neural network includes a third plurality of fully-connected neural network layers to process the height, width and center of the first vehicle image patch to determine a 3D position.

9. The method of claim 1, further comprising training the deep neural network to estimate 3D pose based on an image patch, width, height, and center of a first vehicle and ground truth regarding the 3D pose of a first vehicle based on simulated image data.

10. A system, comprising a processor; and
a memory, the memory including instructions to be executed by the processor to:
crop an image based on a width, height and center of a first vehicle in the image to determine an image patch;
estimate a 3D pose of the first vehicle based on inputting the image patch and the width, height and center of the first vehicle into a deep neural network; and
operate a second vehicle based on the estimated 3D pose.

11. The system of claim 10, wherein the estimated pose includes an estimated 3D position, an estimated roll, an estimated pitch and an estimated yaw of the first vehicle with respect to a 3D coordinate system.

12. The system of claim 10, further comprising determining the width, height and center of the first vehicle image patch based on determining objects in the image based on segmenting the image.

13. The system of claim 12, further comprising determining the width, height and center of the first vehicle based on determining a rectangular bounding box in the segmented image.

14. The system of claim 13, further comprising determining the image patch based on cropping and resizing image data from the rectangular bounding box to fit an empirically determined height and width.

15. The system of claim 10, wherein the deep neural network includes a plurality of convolutional neural network layers to process the cropped image, a first plurality of fully-connected neural network layers to process the height, width and center of the first vehicle and a second plurality of fully-connected neural network layers to combine output from the convolutional neural network layers and the first fully-connected neural network layers to determine the estimated pose.

16. The system of claim 15, further comprising determining an estimated 3D pose of the first vehicle based on inputting the width, height and center of the first vehicle image patch into the deep neural network to determine estimated roll, an estimated pitch and an estimated yaw.

17. The system of claim 16, further comprising determining an estimated 3D pose of the first vehicle wherein the deep neural network includes a third plurality of fully-connected neural network layers to process the height, width and center of the first vehicle image patch to determine a 3D position.

18. The system of claim 10, further comprising training the deep neural network to estimate 3D pose based on an image patch, width, height, and center of a first vehicle and ground truth regarding the 3D pose of a first vehicle based on simulated image data.

19. A system, comprising:
means for controlling second vehicle steering, braking and powertrain;
means for:
cropping an image based on a width, height and center of a first vehicle to determine an image patch;
estimating a 3D pose of the first vehicle based on inputting the image patch and the width, height and center of the first vehicle into a first deep neural network; and
operating a second vehicle based on the estimated 3D pose of the first vehicle by instructing the means for controlling second vehicle steering, braking and powertrain.

20. The system of claim 19, wherein the estimated pose includes an estimated 3D position, an estimated roll, and estimated pitch and an estimated yaw of the first vehicle with respect to a 3D coordinate system.
